(19) United States
(12) Patent Application Publication
(10) Pub. No.: US 2006/0161748 A1
(43) Pub. Date: Jul. 20, 2006

(54) Backup/recovery system and methods regarding the same

(75) Inventors: George Wang, Chongqing (CN); Yi Min Young, Chongqing (CN)

Correspondence Address: ARENT FOX PLLC, 1050 CONNECTICUT AVENUE, N.W., SUITE 400, WASHINGTON, DC, 20036, US

(73) Assignee: FarStone Tech, Inc.

(21) Appl. No.: 11/331,117

(22) Filed: Jan. 13, 2006

(30) Foreign Application Priority Data
Jan. 14, 2005 (TW) 94101058

(51) Int. Cl. G06F 12/16

(52) U.S. Cl. 711/162

(57) ABSTRACT

A backup/recovery system and methodology that securely backs up every data and status of a computer system. The backup/recovery system is utilized for protecting a computer system, having a volatile storage device and a nonvolatile storage device. The backup system comprises a data processing unit for processing data stored in the volatile storage device and the nonvolatile storage device; a backup unit coupled to the data processing unit for backing up status of the computer system; and a restore unit coupled to the backup unit for restoring status of the computer system.

### CROSS-REFERENCE TO RELATED APPLICATIONS

The present application claims priority, under 35 U.S.C. § 119, to foreign application no. 94101058 filed Jan. 14, 2005 in Taiwan, the contents thereof incorporated by reference herein by its entirety.

### BACKGROUND OF THE INVENTION

1. Field of the Invention

The present invention relates generally to a backup/recovery technique for a computer system, and more particularly to a backup/recovery system and method that securely keeps the history status of the entire computer system.

2. Description of Related Art

Conventional backup/recovery techniques often create backup points to backup data in a computer system for reverting to an earlier version of a file, data, or program. These backup/recovery techniques can be generally classified into two types. The first type is a static backup/recovery technique, and the second type is a dynamic backup/recovery technique.

Backing up data with the static backup technique can normally store the backed-up data over a long period of time. In contrast, the dynamic backup technique has the advantage of using the storage space of a hard disk of the computer system in a more effective way when backing up the data.

Conventional backup/recovery software can also be classified into a static backup/recovery type software and a dynamic backup/recovery type software. The static backup/recovery type software, such as the Ghost software developed by Symantec Corporation, adopts a static backup technique in creating backup points In the data backup process. And the dynamic backup/recovery software, such as the Goback software developed by Adaptec Corporation and the Pro Magic software developed by WASAY Incorporation, adopts a dynamic backup technique in creating backup points In the data backup process.

Such Ghost software developed by Symantec Corporation backs up all valid data of those data being in a state of maintenance. Accordingly to the conventional backup/recovery software, backing up data by this static backup technique takes up fixed storage space of the hard disk in the computer system. Moreover, the backed-up data is kept in a state of perpetuity, independent of other current or future data contained in the hard disk of the computer system.

When the static backup/recovery program is executed to back up data, all data stored in selected partitions of the hard disk is backed up to a file. In addition, when the static backup/recovery type program is executed to recover data, the data from the previously backed up file is restored to the selected partitions of the hard disk.

Such Goback software developed by Adaptec Corporation or Pro Magic software developed by WASAY Incorporation restore the computer system to a previous state, in accordance with the backed up data, from a current state. The valid data is backed up prior to making changes to the data. The backup file contains the backup data and identification information to identify the backup data. Such identification information is useful in restoring the computer system in the future.

Although the conventional backup/recovery software has the backup/recovery capabilities to back up and/or recover data in the non-volatile storage means, such as a hard disk, the conventional backup/recovery software is merely to intercept I/O requests or read and write requests of the file system. In other words, volatile storage means does not store data in the absence of power. The volatile data in the RAM-like cannot be dealt with by the current conventional backup/recovery techniques as well.

Volatile data includes running applications, open ports and files, the live Windows registry and other data in RAM. Volatile data provides transient information on a computer's current state. It will be lost in the absence of power. The conventional backup/recovery software don't restore back the applications status when users were running. For example, users were reviewing a PowerPoint file, updating a word doc, on an ICQ chat, etc. . .

Moreover, a PC user may intend to resumes the computer system after a period of time. For example, he or she plays games stored in the computer system. Accordingly, there is a built-in feature that let's Windows hibernate after the computer has been idle for a certain amount of time. What Windows does is write the current RAM data into the hard disk so then when the user turns off the PC and restart, he or she will continue from where the PC was.

However, the Windows hibernate function is incapable of keeping several states of the computer system in case it is necessary to go back to that time. The user must suspend from operation and just can continue to use the computer system with the only one kept state and without reuse, under the identical OS on the same machine. In addition, Windows hibernate takes as long to both store the current windows state and restore as it does to fully shut down and start up the PC in the first place. For that reason alone Windows hibernate is useless.

### BRIEF SUMMARY OF THE INVENTION

The present invention provides a backup/recovery system and method to resolve the foregoing problems faced by the conventional backup/recovery software. The present invention also has the advantage of providing an overall backup to the computer data. Every computer data, no matter they are stored in volatile storage device or nonvolatile storage device, can be kept and reused permanently.

An object of the present invention is to provide a backup/recovery system and method, wherein every data and at any time the computer data can be protected and restored. The backups of the computer data are permanent, which is recyclable.

Another object of the present invention is to provide a backup/recovery system and method, which can execute in background. The users do not need to turn off the PC after backing up data and status of the computer system. The users can resume the PC from anywhere the PC has been without reboot.

A further object of the present invention is to provide a backup/recovery system and method, which can create a plurality of backup points to keep a plurality of statuses of the computer system. The user may recover any of statuses under any OS installed in the computer system.

In accordance with an aspect of the present invention, a backup system is installed in a computer system. The computer system has a volatile storage device and a nonvolatile storage device. The backup system comprises a data processing unit for processing data stored in the volatile storage device and the nonvolatile storage device; a backup unit coupled to the data processing unit for backing up status of the computer system; and a restore unit coupled to the backup unit for restoring status of the computer system.

In the preferred embodiment of the invention, the backup system further comprises a backup driver. The backup driver is a disk drive, a fixed disk drive, a loadable disk drive, a disk array or a writeable medium. The backup system further comprises a graphic user interface. The graphic user interface instructs a sector data monitor to create a backup point. The sector data monitor backs up data processed by the data processing unit into the backup driver. The sector data monitor backs up data processed by the data processing unit into a remote computer. The sector data monitor backs up status backed up by the backup unit into a remote computer.

In accordance with another aspect of the present invention, a backup method is suitable for backing up data and status of a computer system. The backup method comprises the steps of: backing up data located in a volatile storage device of the computer system; backing up status of the computer system; and backing up data located in a nonvolatile storage device of the computer system.

In the preferred embodiment of the invention, the backup method further comprises the step of backing up status of control unit in the computer system.

In accordance with a further aspect of the present invention, a recovery method is suitable for restoring data and status of a computer system. The recovery method comprises the steps of: restoring data located in a nonvolatile storage device of the computer system; restoring data located in a volatile storage device of the computer system; and restoring status of the computer system.

In the preferred embodiment of the invention, the recovery method further comprises the step of restoring status of control unit in the computer system.

The present invention may best be understood through the following description with reference to the accompanying drawings, in which:

### BRIEF DESCRIPTION OF THE DRAWINGS

FIG. 1 shows a schematic block diagram of a backup/recovery system of a preferred embodiment according to the present invention.

FIG. 2 shows a schematic flow chart of a backup method of the preferred embodiment according to the present invention.

FIG. 3 shows a schematic flow chart of a recovery method of the preferred embodiment according to the present invention.

### DETAILED DESCRIPTION OF THE INVENTION

The present invention will now be described more specifically with reference to the following embodiments. It is to be noted that the following descriptions of preferred embodiments of this invention are presented herein for the purpose of illustration and description only. It is not intended to be exhaustive or to be limited to the precise form disclosed.

The present invention describes a new backup technique for a backup/recovery system to create a plurality of backup points, which can keep a plurality of statuses of the computer system. The data in the volatile storage device of the computer system can be backed up. Accordingly, the user may recover any status of the computer system at any later time.

According to the preferred embodiment of the present invention, a backup system is installed in a computer system. The computer system has a volatile storage device and a nonvolatile storage device. The backup system comprises a data processing unit for processing data stored in the volatile storage device and the nonvolatile storage device; a backup unit coupled to the data processing unit for backing up status of the computer system; and a restore unit coupled to the backup unit for restoring status of the computer system.

The backup system further comprises a backup driver. The backup driver is a disk drive, a fixed disk drive, a loadable disk drive, a disk array or a writeable medium. The backup system further comprises a graphic user interface. The graphic user interface instructs a sector data monitor to create a backup point. The sector data monitor backs up data processed by the data processing unit into the backup driver. The sector data monitor backs up data processed by the data processing unit into a remote computer. The sector data monitor backs up status backed up by the backup unit into a remote computer.

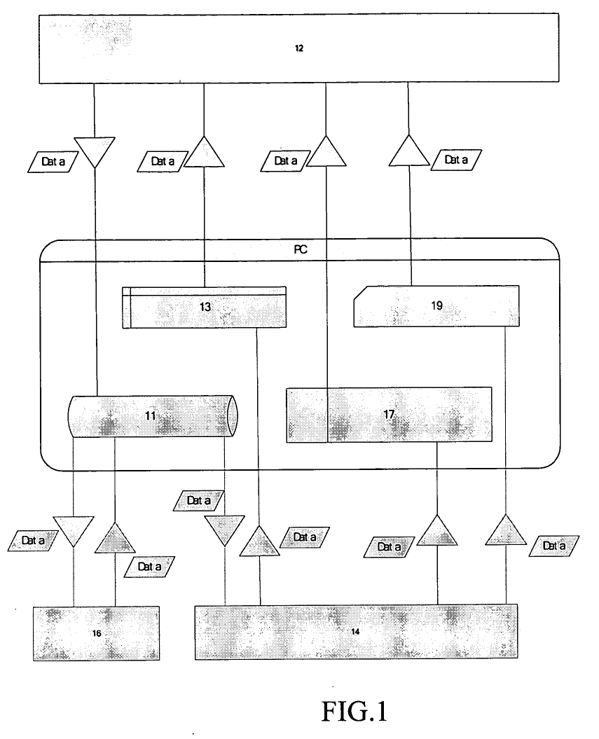

Referring to FIG. 1, a schematic block diagram of a backup/recovery system of a preferred embodiment according to the present invention is shown. The backup/recovery system of the present invention is suitable for a computer system, which has a volatile storage device 11 and a nonvolatile storage device 13. The backup system comprises a data processing unit 12, a backup unit 14 and a restore unit 16.

The data processing unit 12 is used for processing data stored in the volatile storage device 11 and the nonvolatile storage device 13. The nonvolatile storage device 13 is a disk drive, a flash disk drive or a flash ROM. the volatile storage device 11 is a RAM or a SDRAM. The data in the nonvolatile storage device 13 can be instantly backed up. While the data in the volatile storage device 11 can be backed up at the time creating a recovery point.

The data processing unit 12 processes data stored in the nonvolatile storage device 13, intercepts data communicated between the user application and the disk driver. The changed sector data of the nonvolatile storage device 13 is backed up to a backup driver. The backup driver is a disk drive, a fixed disk drive, a loadable disk drive, a disk array or a writeable medium. The changed sector data of the nonvolatile storage device 13 may be backed up to a remote computer through a network interface.

The user can create backup points through a graphic user interface. The graphic user interface instructs a sector data monitor of the data processing unit 12 to create a backup point.

The data in the volatile storage device 11 is processed and written into an area of the nonvolatile storage device 13. The backup unit 14 is coupled to the data processing unit 12, for backing up status of the computer system. The statuses of all of the hardware devices on the bus are stored in the nonvolatile storage device 13. The statuses of all of the registers of the CPU 17 are kept in the nonvolatile storage device 13. The status messages of the hard disk are collected and a backup point is created.

The backup point containing data in the volatile storage device 11, status of the CPU 17, contents and statuses of the hardware control unit 19 is backed up into the backup driver. The backup driver is a disk drive, a fixed disk drive, a loadable disk drive, a disk array or a writeable medium. The changed sector data of the nonvolatile storage device 13 can be backed up to a remote computer through a network interface.

The data processing unit 12 is used for processing data of the nonvolatile storage device 13. The restore unit 16 is coupled to the backup unit 14, for restoring status of the computer system. All the hardware is initialized in accordance with the status messages kept in the nonvolatile storage device 13. The user can restore every data in every status of the computer system at any time. The data processing unit 12 processes data of the volatile storage device 11, which is written into a memory. Then the values of all of the registers of the CPU 17 are restored. The status of all of the hardware devices on the bus are back to the prior status.

According to the preferred embodiment of the present invention, a backup method is suitable for backing up data and status of a computer system. The backup method comprises the steps of: backing up data located in a volatile storage device of the computer system; backing up status of the computer system; and backing up data located in a nonvolatile storage device of the computer system.

The backup method further comprises the step of backing up status of hardware control unit in the computer system.

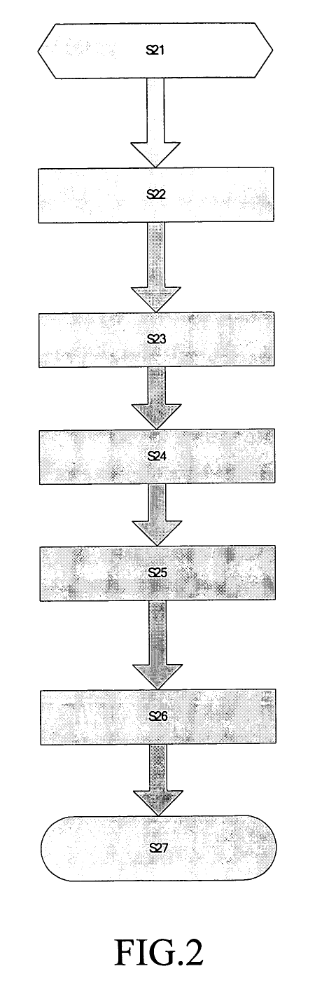

Referring to FIG. 2, a schematic flow chart of a backup method of the preferred embodiment according to the present invention is shown. According to the present invention, the backup method of the present invention is suitable for backing up data and status of a volatile storage device of a computer system. The backup operation can be executed in background without interrupting running of the computer system.

In step S21, the operating system is switched to a protected mode to ensure that essential data is not unintentionally overwritten. In step S22, data in the volatile storage device is read and backed up to a nonvolatile storage device where the operating system is located. In step S23, the status messages of all of the hardware devices on the bus are stored in the nonvolatile storage device.

In step S24, the statuses of all of the registers of the CPU and hardware controller are kept in the nonvolatile storage device. In step S25, the status and the backed-up messages thereof are collected. In step S26, a backup point is created. In step S27, the operating system is switched to an operating mode. The user does not need to reboot the computer system.

According to the preferred embodiment of the present invention, a recovery method is suitable for restoring data and status of a computer system. The recovery method comprises the steps of: restoring data located in a nonvolatile storage device of the computer system; restoring data located in a volatile storage device of the computer system; and restoring status of the computer system.

The recovery method further comprises the step of restoring status of hardware control unit in the computer system.

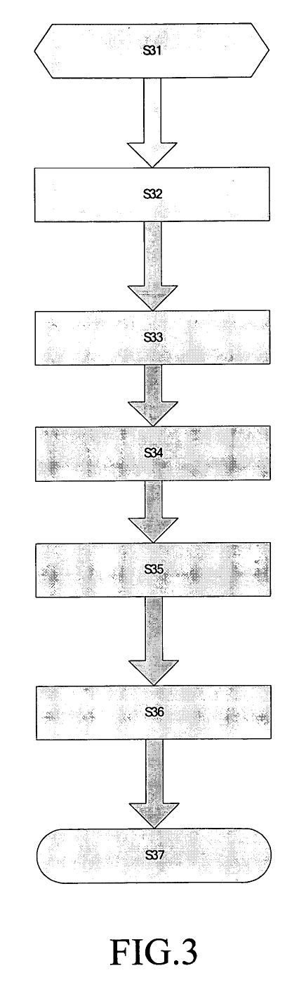

Referring to FIG. 3, a schematic flow chart of a recovery method of the preferred embodiment according to the present invention is shown. According to the present invention, the recovery method of the present invention is suitable for recovering data and status of a volatile storage device of a computer system. The recovery operation can recover every backup point created in the past.

In step S31, user selects an earlier status of the computer system to revert to the data and status created in the backup point. In step S32, restoring data located in a nonvolatile storage device of the computer system under a real mode of the CPU. In step S33, the CPU is switched to a protected mode to enable access of every volatile storage device of a computer system. In step S34, writing data of the volatile storage device stored in the nonvolatile storage device to the volatile storage device of the computer system.

In step S35, all the hardware on the bus is initialized in accordance with the status messages kept in the nonvolatile storage device. In step S36, the values of all of the registers of the CPU are restored. The statuses of hardware control unit in the computer system are back to the prior status.

The present invention allows garners to keep replaying a user-defined portion of a game that otherwise would not allow them to replay or save it in mid-play, thus allowing them to reach the end of each savable section of a game faster -rather than having to start each section over from the beginning. The game play instantly resumes at the backup point, so the gamer can keep trying it again and again in this fashion until he successfully completes the section and reaches a point where he can save the game more quickly than if he had to start over all the way back at the beginning of the section each time he failed.

The present invention keeps backup statuses permanently so that the user may restore the computer system to any prior status of every data with any backup point under any operating system. The present invention also ensures on-line game back to the exactly status when it is backed up. Hence, the shortcoming that the application status cannot be restored can be entirely eliminated.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A backup system, which is installed in a computer system having a volatile storage device and a nonvolatile storage device, said backup system comprising:
a data processing unit for processing data stored in said volatile storage device and said nonvolatile storage device;
a backup unit coupled to said data processing unit for backing up status of said computer system; and
a restore unit coupled to said backup unit for restoring status of said computer system.

2. The backup system according to claim 1, wherein further comprising a graphic user interface.

3. The backup system according to claim 2, wherein said graphic user interface instructs a sector data monitor to create a backup point.

4. The backup system according to claim 3, wherein further comprising a backup driver.

5. The backup system according to claim 4, wherein said sector data monitor backs up data processed by said data processing unit into said backup driver.

6. The backup system according to claim 4, wherein said sector data monitor backs up data processed by said data processing unit into a remote computer.

7. The backup system according to claim 4, wherein said backup driver is a disk drive.

8. The backup system according to claim 4, wherein said backup driver is a fixed disk drive.

9. The backup system according to claim 4, wherein said backup driver is a loadable disk drive.

10. The backup system according to claim 4, wherein said backup driver is a disk array.

11. The backup system according to claim 4, wherein said backup driver is a writeable medium.

12. The backup system according to claim 4, wherein said sector data monitor backs up status backed up by said backup unit into a remote computer.

13. A backup method, suitable for backing up data and status of a computer system, said backup method comprising the steps of: backing up data located in a volatile storage device of said computer system; backing up status of said computer system; and backing up data located in a nonvolatile storage device of said computer system.

14. The backup method according to claim 13, further comprising the step of backing up status of control unit in said computer system.

15. A recovery method, suitable for restoring data and status of a computer system, said recovery method comprising the steps of: restoring data located in a nonvolatile storage device of said computer system; restoring data located in a volatile storage device of said computer system; and restoring status of said computer system.

16. The recovery method according to claim 15, further comprising the step of restoring status of control unit in said computer system.
